(19) United States
(12) Patent Application Publication
(10) Pub. No.: US 2017/0280277 A1
(43) Pub. Date: Sep. 28, 2017

(54) BLUETOOTH INTERCONNECTION METHOD AND SYSTEM FOR WEARABLE DEVICE AND MOBILE TERMINAL

(71) Applicant: HUIZHOU TCL MOBILE COMMUNICATION CO., LTD., Huizhou City (CN)

(72) Inventors: Liangbo Ge, Huizhou (CN); Hai Cai, Huizhou (CN)

(73) Assignee: HUIZHOU TCL MOBILE COMMUNICATION CO., LTD., Huizhou City (CN)

(21) Appl. No.: 15/503,698

(22) PCT Filed: Jul. 29, 2016
(86) PCT No.: PCT/CN2016/092297

§ 371 Date: Feb. 13, 2017

(30) Foreign Application Priority Data
Dec. 2, 2015 (CN) 201510872303.7

(51) Int. Cl. H04W 4/00; H04B 17/318; H04W 76/02

(52) U.S. Cl. CPC H04W 4/008; H04W 76/023; H04B 17/318

(57) ABSTRACT

A method and system for a Bluetooth interconnection between a wearable device and a mobile terminal is described. A plurality of wearable devices advertises information in a low energy mode and a connectable undirected mode; a mobile terminal receives and records the advertising information from the plurality of wearable devices; the mobile terminal sends a connection request to the wearable device with the strongest signal strength; and said wearable device receives the connection request and sends confirmation to said mobile terminal to complete the interconnection.

### TECHNICAL FIELD

The present invention relates to the smart terminal Bluetooth technological field, in particular, to a method and system for wearable device and mobile terminal Bluetooth interconnection.

### BACKGROUND

With the popularization of electronic devices, increasingly more smart devices have appeared, such as smartphone and wearable devices. Such smart wearable devices as smart wrist watches and smart bracelets have been widely used and these wearable devices may realize a plurality of functions via Bluetooth connection with a smartphone, becoming able to synchronously operate phone calls, short messages, photos and music in the smartphone. Currently, their connection with the Bluetooth of a mobile phone is rather inconvenient, or the mobile phone may be required to support special hardware functions such as NFC. For example, some of them may require the user to open the phone Bluetooth and manually search for nearby Bluetooth devices and complete the Bluetooth matching connection by password verification. If two or more Bluetooth devices of the same name are found, the user may not know which is the one he wants to connect to and have to try connections one by one; some of them may require the user to use the phone camera to scan the 2D barcode stored in the wearable device for Bluetooth matching connection; others may require the mobile phone to support NFC function and to read the Bluetooth address in the NFC label on the wearable device by phone NFC. To users, it is not very convenient.

Therefore, the available technology remains to be improved and developed.

### SUMMARY

The present invention aims to solve the problem of inconvenient wearable device and mobile terminal interconnection with the available technology by providing a method and system for wearable device and mobile terminal Bluetooth interconnection.

In an embodiment, a method for wearable device and mobile terminal Bluetooth interconnection is provided, comprising that:

the Bluetooth of wearable devices advertises self-defined information containing their respective Bluetooth addresses and names to the surroundings in a low energy mode and a connectable undirected mode;

the mobile terminal scans and acquires the self-defined advertising information from a plurality of wearable devices and records the corresponding Bluetooth addresses, Bluetooth names and Bluetooth RSSI values thereof;

the Bluetooth of said mobile terminal sends a self-defined connection request to the wearable device whose Bluetooth RSSI value is the strongest; and

upon judging that the mobile terminal is a legitimate connecting device according to the advertising channel, said wearable device receives the connection information and sends confirmation to the Bluetooth of said mobile terminal to complete the interconnection via the GATT layer.

In a further embodiment, said method for wearable device and mobile terminal Bluetooth interconnection, wherein the Bluetooth of said mobile terminal sends a self-defined connection request to the wearable device whose Bluetooth RSSI value is the strongest; comprising:

comparing the Bluetooth RSSI values from a plurality of wearable devices with the preset signal strength threshold to find out the wearable device with the strongest Bluetooth RSSI value from those Bluetooth signals whose strengths are higher than the signal strength threshold and sending a self-defined connection request to the Bluetooth of said wearable device by the Bluetooth of said mobile terminal.

In a further embodiment, said method for wearable device and mobile terminal Bluetooth interconnection, wherein upon judging that the mobile terminal is a legitimate connecting device according to the advertising channel, said wearable device receives the connection information and sends confirmation to the Bluetooth of said mobile terminal to complete the interconnection via the protocol layer of general property, specifically comprising that:

if said wearable device does not receive the user connection request for confirmation within the preset time, the Bluetooth of the mobile terminal will send a self-defined connection to other wearable devices whose Bluetooth signal strengths received are higher than the signal strength threshold in a signal strength sequence from large to small cyclically, and when a wearable device judges that said mobile terminal is a legitimate connecting device according to the advertising channel and exchanges user connection confirmation therewith till the interconnection is completed.

In a further embodiment, said method for wearable device and mobile terminal Bluetooth interconnection, wherein said signal strength threshold is −60 dBm.

In a further embodiment, said method for wearable device and mobile terminal Bluetooth interconnection, wherein said mobile terminal scans and acquires the self-defined advertising information of a plurality of wearable devices and records the corresponding Bluetooth addresses, Bluetooth names and Bluetooth RSSI values thereof, specifically comprising that:

the mobile terminal scans and acquires the self-defined advertising information of a plurality of wearable devices and records the corresponding Bluetooth addresses, Bluetooth names and Bluetooth RSSI values thereof to form a corresponding scanning list; and

said mobile terminal records the wearable devices whose Bluetooth names are in conformity with the Bluetooth name requirement in the said scanning list according to the preset or user-selected Bluetooth name requirement.

In a further embodiment, said method for wearable device and mobile terminal Bluetooth interconnection, before comparing the Bluetooth RSSI values corresponding to a plurality of wearable devices with the preset signal strength threshold, also comprising:

establishing a Bluetooth name threshold-associated list; and

matching the Bluetooth names with the Bluetooth name threshold-associated list to get the corresponding signal strength threshold.

In a further embodiment, a method for wearable device and mobile terminal Bluetooth interconnection, comprising that:

the Bluetooth of wearable devices advertises self-defined information containing their respective Bluetooth addresses and names to the surroundings in a low energy mode and a connectable undirected mode;

a mobile terminal scans and acquires the self-defined advertising information from a plurality of wearable devices and records the corresponding Bluetooth addresses, Bluetooth names and Bluetooth RSSI values thereof;

the Bluetooth of said mobile terminal sends a self-defined connection request to the wearable device whose Bluetooth RSSI value is the strongest and said wearable device receives the connection information and sends confirmation to the Bluetooth of said mobile terminal to complete the interconnection via the protocol layer of general property.

In a further embodiment, said method for wearable device and mobile terminal Bluetooth interconnection, wherein the Bluetooth of said mobile terminal sends a self-defined connection request to the wearable device whose Bluetooth RSSI value is the strongest and said wearable device receives the connection information and sends confirmation to the Bluetooth of said mobile terminal to complete the interconnection via the GATT layer, specifically comprising:

comparing the Bluetooth RSSI values from a plurality of wearable devices with the preset signal strength threshold to find out the wearable device with the strongest Bluetooth RSSI value from those Bluetooth signals whose strengths are higher than the signal strength threshold and sending a self-defined connection request to the Bluetooth of said wearable device by the Bluetooth of said mobile terminal; and

receiving the connection request and sending the confirmation to the Bluetooth of said mobile terminal via the GATT layer by said wearable device to complete interconnection.

In a further embodiment, said method for wearable device and mobile terminal Bluetooth interconnection, wherein said wearable device receives the connection request and sends confirmation to the Bluetooth of said mobile terminal to complete the interconnection via the GATT layer, specifically comprising that:

if said wearable device does not receive the user connection request for confirmation within the preset time, the Bluetooth of the mobile terminal will send a self-defined connection request to other wearable devices whose Bluetooth signal strengths received are higher than the signal strength threshold in a signal strength sequence from large to small cyclically, and exchanges user connection confirmation therewith till the interconnection is completed.

In a further embodiment, said method for wearable device and mobile terminal Bluetooth interconnection, wherein said signal strength threshold is −60 dBm.

In a further embodiment, said method for wearable device and mobile terminal Bluetooth interconnection, wherein said mobile terminal scans and acquires the self-defined advertising information from a plurality of wearable devices and records the corresponding Bluetooth addresses, Bluetooth names and Bluetooth RSSI values thereof, specifically comprising that:

the mobile terminal scans and acquires the self-defined advertising information from a plurality of wearable devices and records the corresponding Bluetooth addresses, Bluetooth names and Bluetooth RSSI values thereof to form a corresponding scanning list; and

the mobile terminal records the wearable devices whose Bluetooth names are in conformity with the Bluetooth name requirement in the said scanning list according to the preset or user-selected Bluetooth name requirement.

In a further embodiment, said method for wearable device and mobile terminal Bluetooth interconnection, before comparing the Bluetooth RSSI values corresponding to a plurality of wearable devices with the preset signal strength threshold, also comprising:

establishing a Bluetooth name threshold-associated list; and

matching the Bluetooth names with the Bluetooth name threshold-associated list to get the corresponding signal strength threshold.

In a further embodiment, a system for wearable device and mobile terminal Bluetooth interconnection, comprising:

an advertising module for advertising self-defined information containing the corresponding Bluetooth addresses and names to the surroundings in a low energy mode and a connectable undirected mode by wearable devices;

a scanning module used for scanning and acquiring the self-defined advertising information from a plurality of wearable devices and recording the corresponding Bluetooth addresses, Bluetooth names and Bluetooth RSSI values thereof by mobile terminal; and

an interconnection module for sending a self-defined connection request to the wearable device whose Bluetooth RSSI value is the strongest by the Bluetooth of said mobile terminal and receiving the connection information and sending confirmation to the Bluetooth of said mobile terminal by said wearable device to complete the interconnection via the GATT layer.

In a further embodiment, said system for wearable device and mobile terminal Bluetooth interconnection, wherein said interconnection module comprises:

a Bluetooth request unit for comparing the Bluetooth RSSI values from a plurality of wearable devices with the preset signal strength threshold to find out the wearable device with the strongest Bluetooth RSSI value from those wearable devices whose strengths are higher than the signal strength threshold and sending a self-defined connection request to the Bluetooth of said wearable device by the Bluetooth of said mobile terminal; and

a Bluetooth confirmation unit for receiving the connection information and sending confirmation to the Bluetooth of said mobile terminal by said wearable device to complete the interconnection via the GATT layer.

In a further embodiment, said system for wearable device and mobile terminal Bluetooth interconnection, wherein said Bluetooth confirmation unit comprises:

a Bluetooth confirmation judgment unit used for that, if said wearable device does not receive the user connection request for confirmation within the preset time, the Bluetooth of the mobile terminal will send a self-defined connection request to other wearable devices whose Bluetooth signal strengths received are higher than the signal strength threshold in a signal strength sequence from large to small cyclically and exchanges user connection confirmation therewith till the interconnection is completed.

In a further embodiment, said system for wearable device and mobile terminal Bluetooth interconnection, wherein said signal strength threshold is −60 dBm.

In a further embodiment, said system of wearable device and mobile terminal Bluetooth interconnection, wherein said scanning module comprises:

a scanning list generation unit for scanning and acquiring the self-defined advertising information from a plurality of wearable devices and recording the corresponding Bluetooth addresses, Bluetooth names and Bluetooth RSSI values thereof by the mobile terminal to form a corresponding scanning list; and

a scanning list screening unit for recording the wearable devices whose Bluetooth names are in conformity with the Bluetooth name requirement in the said scanning list by the mobile terminal according to the preset or user-selected Bluetooth name requirement.

The method and system for wearable device and mobile terminal Bluetooth interconnection of the present invention can effectively solve the problem of inconvenient interconnection between a wearable device and a mobile terminal with the available technology, wherein the Bluetooth of wearable devices advertises self-defined information containing their respective Bluetooth addresses and names to the surroundings in a low energy mode and a connectable undirected mode; a mobile terminal scans and acquires the self-defined advertising information from a plurality of wearable devices and records the corresponding Bluetooth addresses, Bluetooth names and Bluetooth RSSI values thereof; the Bluetooth of said mobile terminal sends a self-defined connection request to the wearable device whose Bluetooth RSSI value is the strongest; and said wearable device receives the connection information and sends confirmation to the Bluetooth of said mobile terminal to complete the interconnection via the GATT layer. When a mobile terminal is made to be close to a wearable device, the mobile terminal will automatically connect to the wearable device. During the entire process, the user operation is simple and needs no manual setting for a very convenient interconnection, thus bringing greater convenience to the user.

### BRIEF DESCRIPTION OF THE DRAWINGS

FIG. 1 depicts a flow chart of a method for wearable device and mobile terminal Bluetooth interconnection, according to an exemplary embodiment of the present invention.

FIG. 2 is a block diagram of a system for wearable device and mobile terminal Bluetooth interconnection, according to an exemplary embodiment of the present invention.

### DETAILED DESCRIPTION

The present invention provides a method and system for wearable device and mobile terminal Bluetooth interconnection. To enable a better and clearer understanding of the purpose, technical solution and advantages of the present invention, the present invention will be further described by means of embodiments and attached drawings. It should be understandable that the embodiments described herein are used only to illustrate but not to restrict the present invention.

First, the low energy Bluetooth protocol is to be described in detail as follows.

The advantages of Bluetooth lower energy (BLE) include less energy and small data transmission volume. The development of BLE protocol is mainly on its link layer (LL), generic access profile (GAP), and GATT layer, which are as follows.

With respect to link layer (LL), according to the low energy protocol issued by Bluetooth Special Interest Group (Bluetooth SIG), LL defines the signaling of BLE channel and the role and mode of advertising channel. The BLE channel signaling format is as shown in Table 1 and is applicable to advertising channel and data channel, wherein the preamble and access address are fixed data for BLE channel, protocol data unit (PDU) may carry information in BLE channel and cyclic redundancy check (CRC) is used for cyclic check.

TABLE 1

| | | | |
|---|---|---|---|
| Preamble | Access Address | PDU | CRC |
| 1 Byte | 4 Bytes | 2 to 39 Bytes | 3 Bytes |

With respect to the signaling format of advertising channel, the signaling PDU of advertising channel is composed of header and payload as shown in Table 1, and Table 2 shows the signaling format of advertising channel.

TABLE 2

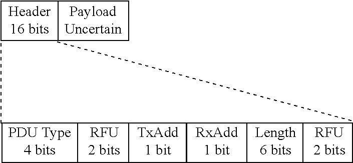

The 4-bit PDU type in header decides the signaling type of advertising channel, such as connectable undirected advertising signaling (ADV_IND), connectable directed advertising signaling (ADV_DIRECT_IND), non-connectable undirected advertising signaling (ADV_NONCONN_IND), scanning request signaling (SCAN_REQ), scanning reply signaling (SCAN_RSP), connection request signaling (CONNECT_REQ) and scannable undirected advertising signaling (ADV_SCAN_IND). See Table 3 for detailed signaling types of advertising channel.

TABLE 3

| PDU Type | Packet Name |
|---|---|
| 0000 | ADV_IND |
| 0001 | ADV_DIRECT_IND |
| 0010 | ADV_NONCONN_IND |
| 0011 | SCAN_REQ |
| 0100 | SCAN_RSP |
| 0101 | CONNECT_REQ |
| 0110 | ADV_SCAN_IND |
| 0111-1111 | Reserved |

With respect to connectable undirected advertising signaling, the payload format that may connect therewith is as shown in Table 4, wherein AdvA represents the Bluetooth address of the advertiser and AdvData represents the advertising data packet that may carry at most 31 bytes.

TABLE 4
Payload

| | |
|---|---|
| AdvA | AdvData |
| 6 Bytes | 0-31 Bytes |

The format of advertising data packet is as shown in Table 5, wherein AD Structure represents message segments and one packet may contain a plurality of message segments; AD Type represents the type of message segment, such as Bluetooth name, Bluetooth manufacturer, UUID, etc.; AD Data represents the content of message segment; and the length value represents the data byte number. Table 5 shows the advertising data packet format of connectable undirected advertising signaling.

TABLE 5

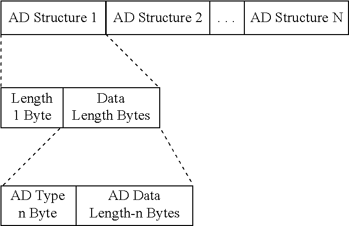

The AD Type fields already defined by Bluetooth SIG, wherein represents the Bluetooth name type and those undefined are reserved fields. Table 6 shows the universal set of AD type fields defined by Bluetooth SIG.

TABLE 6

| | | | | | | | |
|---|---|---|---|---|---|---|---|
| 0x01 | 0x02 | 0x03 | 0x04 | 0x05 | 0x06 | 0x07 | 0x08 |
| 0x09 | 0x0A | 0x0D | 0x0E | 0x0F | 0x10 | 0x11 | 0x12 |
| 0x14 | 0x1F | 0x15 | 0x16 | 0x20 | 0x21 | 0x17 | 0x18 |
| 0x19 | 0x1A | 0x1B | 0x1C | 0x1D | 0x1E | 0x3D | 0xFF |

With respect to the connection request signaling, the payload format thereof is as shown in Table 7, wherein InitA is the Bluetooth address of the scanning party, AdvA is the Bluetooth address of the advertiser, and LL data is the content of connection request. Table 7 shows the payload format of connection request signaling.

TABLE 7
Payload

| | | |
|---|---|---|
| InitA | AdvA | LL Data |
| 6 Bytes | 6 Bytes | 22 Bytes |

The LL data format is as shown in Table 8, wherein channel match (Chm) is used for selecting the channel for data transmission. Table 8 is the LL data format of connection request.

TABLE 8

| | | | | | | | | | |
|---|---|---|---|---|---|---|---|---|---|
| AA | CRCInit | WinSize | WinOffset | Interval | Latency | Timeout | ChM | Hop | SCA |
| 4 Bytes | 3 Bytes | 1 Byte | 2 Bytes | 2 Bytes | 2 Bytes | 2 Bytes | 5 Bytes | 5 bits | 3 bits |

In ChM, 37 bytes represent data channel (0˜36) and 3 bytes represent advertising channel (37˜39), as shown in Table 9. Three-byte advertising channel is reserved for the future. Table 9 is the channel matching ChM format.

TABLE 9

| | |
|---|---|
| Data Channel Index | Advertising Channel Index |

| | | | | | | |
|---|---|---|---|---|---|---|
| 0 | 1 | . . . | 36 | 37 | 38 | 39 |

With respect to the role and statue of advertising channel, LL has defined 3 roles in advertising channel: advertiser, scanner and initiator.

LL has defined 3 modes of advertising channel: advertising mode, scanning mode and initiating mode. Said advertising mode includes:

connectable undirected event: the advertiser advertises the ADV_IND signaling to all surrounding scanners, stating that it is now connectable. The advertiser monitors the SCAN_REQ signaling sent by scanners and sends the SCAN_RSP signaling to the scanners. The advertiser also monitors the CONNECT_REQ signaling from the initiator.

connectable directed event: the advertiser advertises the ADV_DIRECT_IND signaling only to special surrounding scanners, stating that it is now connectable. The advertiser monitors only the CONNECT_REQ signaling from the special initiator.

non-connectable undirected event: the advertiser advertises the ADV_NONCONN_IND signaling to all surrounding scanners, stating that it is now connectable. The advertiser does not monitor the signaling from the scanners.

scannable undirected event: the advertiser advertises the ADV_SCAN_IND signaling to all surrounding scanners, stating that it is now connectable. The advertiser monitors only the SCAN_REQ signaling from the scanners and then sends the SCAN_RSP singling to the scanners.

Said scanning mode includes:

passive scanning: a scanner in the passive scanning mode only monitors the advertising signaling from advertisers but can not send out data;

active scanning: a scanner in the active scanning mode monitors the advertising signaling from advertisers and only sends the SCAN_REQ signaling to the advertisers advertising ADV_IND signaling and ADV_SCAN_IND signaling, and after sending, continues to monitor the SCAN_RSP signaling from advertisers.

Said initiating mode includes that:

an initiator in initiating mode may send the CONNECT_REQ signaling to the advertisers advertising the ADV_IND signaling and ADV_DIRECT_IND signaling.

The signaling relations corresponding to the 3 modes of advertising channel are shown in Table 10. Table 10 shows the signaling relations corresponding to the advertising mode, scanning mode and initiating mode of advertising channel.

TABLE 10

| | PDU in | Response PDU for advertising event | |
|---|---|---|---|
| Advertising event | advertising event | SCAN_REQ | CONNECT_REQ |
| Connectable undirected event | ADV_IND | YES | YES |
| Connectable directed event | ADV_DIRECT_IND | NO | YES |
| Non-connectable undirected event | ADV_NONCONN_IND | NO | NO |
| Scannable undirected event | ADV_SCAN_IND | YES | NO |

With respect to generic access protocol (GAP): GAP layer has defined 4 roles: advertiser (broadcaster) role, observer role, peripheral role and central role. Advertiser role: the device in advertiser role advertises to the surroundings in a low energy mode but will not affect the connection request from any other device, i.e. the device in advertiser role is in non-connectable mode. Observer role: the device in observer role may scan devices in advertiser role but can not issue a connection request, i.e. the device in observer role is in non-connectable mode. Peripheral role: the device in peripheral role advertises to the surroundings in a low energy mode and will affect the connection request from any other device, i.e. the device in advertiser role is in connectable mode. Central role: the device in central role may scan devices in peripheral role and issue a connection request, i.e. the device in central role is in connectable mode.

The correlation between LL layer and GAP layer is shown as in Table 11 and Table 11 is the correlation between LL layer and GAP layer.

TABLE 11

| | Broad- | | | |
|---|---|---|---|---|
| Link Layer functionality | caster | Observer | Peripheral | Central |
| Advertising event types: | | | | |
| Connectable undirected event | E | E | M | E |
| Connectable directed event | E | E | O | E |
| Non-connectable undirected | M | E | O | E |
| event | | | | |
| Scannable undirected event | O | E | O | E |
| Scanning types: | | | | |
| Passive scanning | E | M | E | O |
| Active scanning | E | O | E | O/E |

In Table 11, “E” represents non-support, “M” represents a support must, “O” represents an optional support, and “O/E” means if the central role supports passive scanning, the central role will select to support active scanning, and if not, the central role must support active scanning.

With respect to generic attribute profile (GATT), GATT layer has defined server and client. The server may transmit date to the client while the client may not transmit data to the server, as shown in Table 12, which is the communication mechanism of GATT layer.

TABLE 12

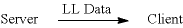

When two BLE devices are successfully connected, it means they enter the GATT layer from GAP layer, the original central role and peripheral role turn to be the server and the client, and the original central role and peripheral role may be a server or a client or both server and client at the same time.

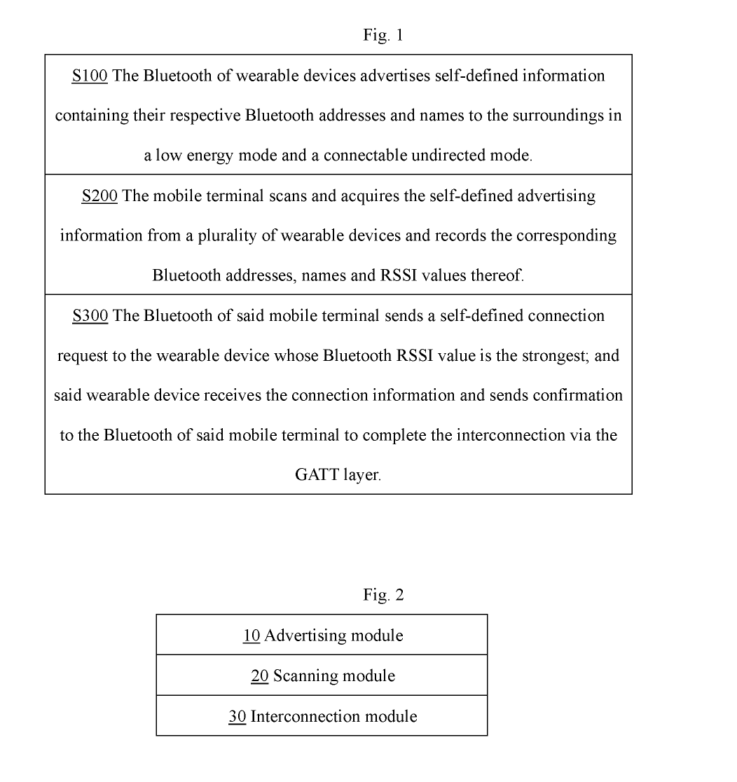

The present invention defines the following two physical device types as shown in FIG. 1, including wearable devices and mobile terminals, wherein the wearable devices include smart watch, smart bracelet, smart eyeglasses, etc. and the mobile terminals include mobile phones, tablet computers, etc.

Please refer to FIG. 1, which is the flow chart of a preferred embodiment of the method for wearable device and mobile terminal Bluetooth interconnection provided by the present invention, as shown in the figure, said method may include:

the Bluetooth of wearable devices advertises self-defined information containing their respective Bluetooth addresses and names to the surroundings in a low energy mode and a connectable undirected mode. (Block S100)

the mobile terminal scans and acquires the self-defined advertising information from a plurality of wearable devices and records the corresponding Bluetooth addresses, Bluetooth names and Bluetooth RSSI values thereof. (Block S200)

the Bluetooth of said mobile terminal sends a self-defined connection request to the wearable device whose Bluetooth RSSI value is the strongest; and said wearable device receives the connection information and sends confirmation to the Bluetooth of said mobile terminal to complete the interconnection via the GATT layer. (Block S300)

The foregoing will be described in detail in combination with an embodiment.

In Block S100, the Bluetooth of wearable devices advertises self-defined information containing their respective Bluetooth addresses and names to the surroundings in a low energy mode and a connectable undirected mode. Specifically, the Bluetooth of wearable devices advertises self-defined information to the surroundings in a low energy mode and a “connectable undirected” mode.

In the actual application, the Bluetooth of wearable devices advertises self-defined message as shown in Table 13 to the surroundings in a low energy mode and a “connectable undirected” mode, enabling a mobile terminal (such as a mobile phone) to identify that such devices are legitimate. The self-defined advertising message also includes the Bluetooth names with specific meanings, such as xxx smart watch I, xxx smart watch II, xxx smart bracelet I, xxx smart eyeglass II, etc., and such Bluetooth names are used to differentiate the types and models of wearable devices. Table 13 is the Bluetooth self-defined advertising data packet of wearable devices.

TABLE 13

| Length | AD Type | AD Data |
|---|---|---|
| 1E | 49 | 000 . . . 000 |
| 1 Byte | 1 Byte | 29 Bytes |

In the table, the length value represents the total number of bytes of AD Type and AD Data: the value of AD Type is “49” and has not been defined by Bluetooth SIG to prevent interference to other BLE devices and the AD Type fields that have been defined by Bluetooth SIG are as shown in Table 6.

In Block S200, the mobile terminal scans and acquires the self-defined advertising information from a plurality of wearable devices and records the corresponding Bluetooth addresses, Bluetooth names and Bluetooth RSSI values thereof. Specifically, the wearable devices around a mobile terminal may be more than one.

The Bluetooth of the mobile phone initiatively scans the surrounding Bluetooth signals and when finding any Bluetooth self-defined advertising message of wearable devices needing connection, records their Blue addresses, names and RSSI (received signal strength indication) values to form a scanning list of wearable devices as shown in Table 14, which is the scanning list of wearable devices.

TABLE 14

| Wearable device | Device model | RSSI |
|---|---|---|
| (Bluetooth address | (Bluetooth name) | value (dBm) |
| 1 | xxx smart watch I | −50 |
| 2 | xxx smart bracelet I | −65 |
| 3 | xxx smart eyeglass II | −45 |
| . . . | | . . . |
| N | xxx smart watch II | −72 |

In Block S300, the Bluetooth of the mobile terminal sends a self-defined connection request to the wearable device whose Bluetooth RSSI is the strongest; and said wearable device receives the connection information and sends confirmation to the Bluetooth of said mobile terminal to complete the interconnection via the GATT layer. Specifically, the Bluetooth of the mobile phone first sends a self-defined connection request to the wearable device whose Bluetooth RSSI is the strongest. The self-defined 37^{th}˜39^{th} bits in ChM as shown in Table 9 is “001”, which enables the wearable device to identify that said mobile phone is a legitimate connecting device and therefore, be able to send a user connection confirmation to the mobile phone after the connection is established without affecting normal BLE communication. Then, the Bluetooth of the mobile phone and that of the wearable device may exchange user connection confirmation information in the GATT layer so as to complete the interconnection.

Preferably, said Block S200 comprises:

Block S210, wherein the mobile terminal scans and acquires the self-defined advertising information from a plurality of wearable devices and records the corresponding Bluetooth addresses, Bluetooth names and Bluetooth RSSI values thereof to form a corresponding scanning list; and

Block S220, wherein the mobile phone records the wearable devices whose Bluetooth names are in conformity with the Bluetooth name requirement in the said scanning list according to the preset or user-selected Bluetooth name requirement.

Specifically, the Bluetooth of the mobile phone initiatively scans the surrounding Bluetooth signals and when finding any Bluetooth self-defined advertising message of wearable devices needing connection, records their Blue addresses, names and RSSI values to form a scanning list of wearable devices as shown in Table 14. The mobile phone APP will preset or set the types and models (i.e. Bluetooth name) of wearable devices needing to be connected according to the user selection, and the mobile phone will only record the wearable devices in conformity with the preset requirements and capable of advertising self-defined advertising message in the scanning list of wearable devices.

Preferably, said Block S300 comprises:

Block S310, wherein the Bluetooth RSSI values from a plurality of wearable devices are compared with the preset signal strength threshold to find out the wearable device with the strongest Bluetooth RSSI value from those Bluetooth signals whose strengths are higher than the signal strength threshold and then, the Bluetooth of said mobile terminal sends a self-defined connection request to the Bluetooth of said wearable device.

Block S320, wherein said wearable device receives the connection request and sends confirmation to said mobile terminal to complete the interconnection.

Specifically, when there is one or more recorded Bluetooth received signal strength (Bluetooth RSSI) values greater than the signal strength threshold (e.g. −60 dBm), the Bluetooth of the mobile phone will first send a self-defined connection request to the wearable device whose Bluetooth RSSI is the strongest. Then, the Bluetooth of the mobile phone and that of the wearable device may exchange user connection confirmation information in the GATT layer so as to complete the interconnection.

When there is one or more recorded Bluetooth RSSI values greater than the signal strength threshold (e.g. −60 dBm), the Bluetooth of the mobile phone will first send a self-defined connection request to the wearable device whose Bluetooth RSSI is the strongest. The self-defined 37^{th}˜39^{th} bits in ChM as shown in Table 9 is “001”, which enables the wearable device to identify that said mobile phone is a legitimate connecting device and therefore, be able to send a user connection confirmation to the mobile phone after the connection is established without affecting normal BLE communication. Then, the Bluetooth of the mobile phone and that of the wearable device may exchange user connection confirmation information in the GATT layer so as to complete the interconnection.

Further, said signal strength threshold is −60 dBm. With respect to the setting of Bluetooth RSSI threshold F or signal strength, in principle, there is a certain linear relationship between the Bluetooth RSSI value received by the receptor and the distance. That is the Bluetooth value is reduced with the increase of the distance between two Bluetooth devices. But in fact, as the Bluetooth transmitting and receiving antenna is not a complete omnidirectional one and the devices themselves may also block Bluetooth signals, the Bluetooth RSSI values received in different directions over the same distance may greatly vary. If the Bluetooth RSSI threshold F is set too high, it will increase the difficult in automatic Bluetooth connection, needing the user to get the mobile phone and the wearable device to be connected very near to each other for a successful connection; if the Bluetooth RSSI threshold F is set too low, misconnection may be caused, and Bluetooth connection request may be initiated to other nearby users' wearable devices of the same model that reach the RSSI threshold. Therefore, the basic principle for setting the Bluetooth RSSI threshold F is: it should guarantee that the mobile phone can successfully connect to the wearable device in a near distance range (e.g. 10 cm) in most directions and can also avoid misconnection with other users' wearable devices of the same model in a far distance range (e.g. over 50 cm). To improve the successful near distance connection rate, when the mobile phone APP is to initiate a Bluetooth connection with a wearable device, the APP interface of the mobile phone may prompt the user to get the mobile phone approach the wearable device as near as possible.

The setting of Bluetooth RSSI threshold F may be properly adjusted according to the Bluetooth RSSI testing data of the product in different distances and directions, and different RSSI threshold F values may be set for wearable devices of different types and models, respectively, i.e. setting different Bluetooth RSSI threshold values according to the Bluetooth names of wearable devices: F1, F2, F3, etc. For example, a test was made on the Bluetooth RSSI values between a mobile phone of certain model and a smart watch of certain mode in various distances and directions and the test results indicated that it was proper to set the Bluetooth RSSI threshold F to be −60 dBm, which can guarantee that the mobile phone can successfully connect to the smart watch within 10 cm range in most directions and can also avoid misconnection with the smart watches of the same model that are 30 cm away.

Preferably, said Block S320 comprises:

Block S321, wherein, if said wearable device does not receive the user connection request for confirmation within the preset time, the Bluetooth of the mobile terminal will send a self-defined connection request to other wearable devices whose Bluetooth RSSI values are higher than the signal strength threshold in a signal strength sequence from large to small circularly, and exchanges user connection confirmation therewith till the interconnection is completed.

Specifically, the Bluetooth of the mobile phone and that of the wearable device will exchange user connection confirmation information in the GATT layer so as to complete the interconnection. If not receiving the user connection request for confirmation after a certain time (i.e. a preset time such as 10 sec), the Bluetooth of the mobile terminal will send a self-defined connection request to other wearable devices whose Bluetooth RSSI values in the scanning list of wearable devices are higher than the signal strength threshold F in a signal strength sequence from large to small circularly, and exchanges user connection confirmation therewith till the interconnection is completed.

The user connection confirmation information may be displayed in the screen of the wearable device, or the user may be informed thereof by light flash or voice. The user may send feedback to the mobile terminal by clicking the “Confirm” button on the screen of the wearable device, long pressing a certain physical button on the wearable device or continuous shaking the wearable equipment.

That is to say that when the mobile terminal sends a connection request to a wearable device, the user of the wearable device will receive the user connection request and send the confirmation to the mobile terminal. If this wearable device is not the one the user intends to connect, the mobile terminal will not receive the response from the wearable device and may continue to connect the wearable device whose Bluetooth RSSI value is the second strongest in the Bluetooth connection scanning list and so on till it gets the response from the wearable device. What should be explained is that Bluetooth RSSI values of the wearable devices the mobile phone connects are all higher than the signal strength threshold. When the connection with all such wearable devices have been tried once, such recycle may be continued or the sending of Bluetooth connection request may be stopped, which may be preset in light of needs. Recycling is preferred.

According to the method for wearable device and mobile terminal Bluetooth interconnection provided by the present invention, when the user opens the wearable device, its Bluetooth and then the corresponding APP in the mobile phone to initiate the connection with the wearable device and meanwhile, gets the mobile phone to approach the wearable device, the mobile phone APP will automatically open the Bluetooth of the mobile phone to complete the connection with the Bluetooth of the wearable device. The wearable device advertises self-defined advertising message containing its special Bluetooth name. The Bluetooth of the mobile phone scans the wearable device with the special Bluetooth name and detects the Bluetooth RSSI value of the wearable device. With the decrease of the distance between the mobile phone and the wearable device, when the Bluetooth RSSI value of the wearable device is higher than the preset value, the mobile phone will automatically connect to the wearable device. The user needs only to open the APP of the mobile phone and have the mobile to approach the wearable device, and the mobile phone will then be able to automatically connect to the wearable device. During the entire process, the user operates conveniently without needing any manual setting.

Based on the foregoing method for wearable device and mobile terminal Bluetooth interconnection, the embodiment of the present invention also provides a system for wearable device and mobile terminal Bluetooth interconnection.

Advertising module 10 for advertising self-defined information containing the corresponding Bluetooth addresses and names to the surroundings in a low energy mode and a connectable undirected mode by wearable devices, with the specific procedure as shown in Block S100.

Scanning module 20 for scanning and acquiring the self-defined advertising information from a plurality of wearable devices and recording the corresponding Bluetooth addresses, Bluetooth names and Bluetooth RSSI values thereof by mobile terminal, with the specific procedure as shown in Block S200.

Interconnection module 30 for sending a self-defined connection request to the wearable device whose Bluetooth RSSI value is the strongest by the Bluetooth of the mobile terminal and receiving the connection information and sending confirmation to the Bluetooth of said mobile terminal by said wearable device to complete the interconnection via the GATT layer, with the specific procedure as shown in Block S300.

Further, said interconnection module 30 comprises:

a Bluetooth request unit for comparing the Bluetooth RSSI values from a plurality of wearable devices with the preset signal strength threshold to find out the wearable device with the strongest Bluetooth RSSI value from those wearable devices whose strengths are higher than the signal strength threshold and sending a self-defined connection request to the Bluetooth of said wearable device by the Bluetooth of said mobile terminal; and

a Bluetooth confirmation unit for receiving the connection information and sending confirmation to the Bluetooth of said mobile terminal by said wearable device to complete the interconnection via the GATT layer.

Further, said Bluetooth confirmation unit comprises:

a Bluetooth confirmation judgment unit used for that, if said wearable device does not receive the user connection request for confirmation within the preset time, the Bluetooth of the mobile terminal will send a self-defined connection request to other wearable devices whose Bluetooth signal strengths received are higher than the signal strength threshold in a signal strength sequence from large to small circularly and exchanges user connection confirmation therewith till the interconnection is completed.

Further, said signal strength threshold is −60 dBm. The dBM which is a signal strength unit will not be described further as it is an available technique.

Further, said scanning module 20 comprises:

a scanning list generation unit for scanning and acquiring the self-defined advertising information from a plurality of wearable devices and recording the corresponding Bluetooth addresses, Bluetooth names and Bluetooth RSSI values thereof by the mobile terminal to form a corresponding scanning list; and

a scanning list screening unit for recording the wearable devices whose Bluetooth names are in conformity with the Bluetooth name requirement in the said scanning list by the mobile terminal according to the preset or user-selected Bluetooth name requirement.

In summary, the present invention provides a method and system for wearable device and mobile terminal Bluetooth interconnection, wherein the Bluetooth of wearable devices advertises self-defined information containing their respective Bluetooth addresses and names to the surroundings in a low energy mode and a connectable undirected mode; the mobile terminal scans and acquires the self-defined advertising information from a plurality of wearable devices and records the corresponding Bluetooth addresses, names and received RSSI values thereof; the Bluetooth of said mobile terminal sends a self-defined connection request to the wearable device whose RSSI is the strongest; said wearable device receives the connection request and sends confirmation to said mobile terminal to complete the interconnection; and when approaching the wearable device, the mobile terminal will automatically connect with the wearable device. During the entire process, the user operation is simple and needs no manual setting for a very convenient interconnection, thus bringing greater convenience to the user.

It should be understandable that the application of the present invention is not limited to the foregoing embodiment, and those skilled in the art may make modifications or alterations based on the above description and all such modifications and alterations should be viewed as within the scope of the protection defined by the claims of the present invention.

1. A method for Bluetooth interconnection between a wearable device and a mobile terminal, comprising:
a plurality of wearable devices advertises self-defined information containing Bluetooth addresses and Bluetooth names in a low energy mode and a connectable undirected mode;
the mobile terminal scans and acquires the self-defined advertising information from the plurality of wearable devices and records the Bluetooth addresses, Bluetooth names and received signal strength indications (RSSI);
the mobile terminal sends a self-defined connection request to the wearable device whose RSSI is strongest of the plurality of wearable devices; and
upon judging that the mobile terminal is a legitimate connecting device according to an advertising channel, said wearable device receives connection information and sends a confirmation to said mobile terminal to complete the Bluetooth interconnection via a generic attribute profile (GATT).

2. The method of claim 1, wherein the RSSI of the wearable device whose RSSI is strongest exceeds a signal strength threshold.

3. The method of claim 1, further comprising:
when said wearable device does not receive a user connection request for the confirmation within a preset time, the mobile terminal sends a self-defined connection request to other wearable devices whose Bluetooth RSSI values are higher than a signal strength threshold in a signal strength sequence from large to small cyclically, and when another wearable device judges that said mobile terminal is a legitimate connecting device according to an advertising channel, the mobile terminal exchanges a user connection confirmation with the another wearable device until the interconnection is completed.

4. The method of claim 2, wherein said signal strength threshold is −60 dBm.

5. The method of claim 1, wherein
the mobile terminal scans and acquires the self-defined advertising information to form a corresponding scanning list; and
the mobile terminal records wearable devices whose Bluetooth names are in conformity with Bluetooth name requirements in the scanning list according to preset or user-selected Bluetooth name requirements.

6. The method of claim 2, further comprising, prior to the mobile terminal sending the self-defined connection request:
establishing a Bluetooth name threshold-associated list; and
matching the Bluetooth names with the Bluetooth name threshold-associated list to get the signal strength threshold.

7. A method for Bluetooth interconnection between a wearable device and a mobile terminal, comprising:
a plurality of wearable devices advertises self-defined information containing Bluetooth addresses and Bluetooth names in a low energy mode and a connectable undirected mode;
the mobile terminal scans and acquires the self-defined advertising information from the plurality of wearable devices and records the Bluetooth addresses, Bluetooth names and received signal strength indications (RSSI); and
the mobile terminal sends a self-defined connection request to the wearable device whose Bluetooth RSSI value is strongest of the plurality of wearable devices and said wearable device receives connection information and sends a confirmation to said mobile terminal to complete the Bluetooth interconnection via a GATT layer.

8. The method of claim 7, wherein the Bluetooth RSSI value of the wearable device whose Bluetooth RSSI value is strongest exceeds a signal strength threshold.

9. The method of claim 8, further comprising:
when said wearable device does not receive a user connection request for the confirmation within a preset time, the mobile terminal sends a self-defined connection request to other wearable devices whose Bluetooth signal strengths received are higher than the signal strength threshold in a signal strength sequence from large to small cyclically, and exchanges a user connection confirmation with the other wearable devices until the interconnection is completed.

10. The method of claim 8, wherein said signal strength threshold is −60 dBm.

11. The method of claim 7, wherein
the mobile terminal scans and acquires the self-defined advertising information to form a corresponding scanning list; and
the mobile terminal records the wearable devices whose Bluetooth names are in conformity with Bluetooth name requirements in the scanning list according to preset or user-selected Bluetooth name requirements.

12. The method of claim 8, further comprising, prior to the mobile terminal sending the self-defined connection request:
establishing a Bluetooth name threshold-associated list; and
matching the Bluetooth names with the Bluetooth name threshold-associated list to get the signal strength threshold.

13. A system for Bluetooth interconnection between a wearable device and a mobile terminal, comprising one or more modules configured to:
cause a plurality of wearable devices to advertise self-defined information containing Bluetooth addresses and Bluetooth names in a low energy mode and a connectable undirected mode;
cause the mobile terminal to scan and acquire the self-defined advertising information from the plurality of wearable devices and recording the Bluetooth addresses, Bluetooth names and Bluetooth RSSI values; and
cause the mobile terminal to send a self-defined connection request to the wearable device whose Bluetooth RSSI value is strongest of the plurality of wearable devices;
cause the wearable device to receive connection information and send a confirmation to said mobile terminal to complete the Bluetooth interconnection via a GATT layer.

14. The system of claim 13, wherein the Bluetooth RSSI value that is strongest exceeds a signal strength threshold.

15. The system of claim 14, wherein the one or more modules are further configured to:
when said wearable device does not receive a user connection request for the confirmation within a preset time, the mobile terminal sends a self-defined connection request to other wearable devices whose Bluetooth signal strengths are higher than the signal strength threshold in a signal strength sequence from large to small cyclically and exchanges a user connection confirmation with the other wearable devices until the interconnection is completed.

16. The system of claim 14, wherein said signal strength threshold is −60 dBm.

17. The system of claim 13, wherein said one or more modules are further configured to:
cause the mobile terminal to scan and acquire the self-defined advertising information to form a corresponding scanning list; and
cause the mobile terminal to record the wearable devices whose Bluetooth names are in conformity with Bluetooth name requirements in the scanning list according to preset or user-selected Bluetooth name requirements.

18. The method of claim 6, wherein the Bluetooth name threshold-associated list is based on test results for products identified by the Bluetooth name threshold-associated list.

19. The method of claim 12, wherein the Bluetooth name threshold-associated list is based on test results for products identified by the Bluetooth name threshold-associated list.

20. The system of claim 14, wherein the signal strength threshold is retrieved by matching the Bluetooth names to a Bluetooth name threshold-associated list, wherein the Bluetooth name threshold-associated list is based on test results for products identified by the Bluetooth name threshold-associated list.
